(19) United States
(12) Patent Application Publication
(10) Pub. No.: US 2016/0062610 A1
(43) Pub. Date: Mar. 3, 2016

(54) Information Display System That Displays Appropriate Information Corresponding to Contents of Ongoing Conference or Presentation on Terminal and Recording Medium

(71) Applicant: Kyocera Document Solutions Inc., Osaka (JP)

(72) Inventors: Akira Yuki, Osaka (JP); Masato Tanba, Osaka (JP); Wataru Endo, Osaka (JP); Ayaka Ikejima, Osaka (JP)

(21) Appl. No.: 14/838,308

(22) Filed: Aug. 27, 2015

(30) Foreign Application Priority Data
Aug. 27, 2014 (JP) 2014-172191

(51) Int. Cl. G06F 3/0484; G06F 17/27; G06F 3/0488

(52) U.S. Cl. CPC G06F 3/04842; G06F 3/0488; G06F 17/2765

(57) ABSTRACT

An information display system includes a word recognition device, a server, and a plurality of terminals. The server includes a first communication circuit, a dictionary, and a first control circuit. The first control circuit transmits the received word and the searched explanation to the plurality of terminals. The plurality of terminals each include a second communication circuit, an operation circuit, a display circuit, a storage circuit, and a second control circuit. When receiving the word and the explanation of the word from the server, the second control circuit causes the display circuit to display the received word and causes the storage circuit to store the received explanation. When accepting a selection of the displayed word via the operation circuit, the second control circuit obtains the explanation corresponding to the selected word from the storage circuit to cause the display circuit to display the obtained explanation.

### INCORPORATION BY REFERENCE

This application is based upon, and claims the benefit of priority from, corresponding Japanese Patent Application No. 2014-172191 filed in the Japan Patent Office on Aug. 27, 2014, the entire contents of which are incorporated herein by reference.

### BACKGROUND

Unless otherwise indicated herein, the description in this section is not prior art to the claims in this application and is not admitted to be prior art by inclusion in this section.

There have been various methods are contrived to proceed with a conference or a presentation smoothly, or to efficiently search a time point, to which a user desires to refer, from a medium recording the contents of a conference.

For example, a typical technique proposes a method for efficiently finding out a content to be referred from a conference information database (DB), which records, for example, slide data, audio data during a conference, and hand written characters used during a conference. This technique extracts a keyword during the conference from, for example, slide data, audio data, and hand written characters, and then stores the extracted keyword with an attribution such as importance and abstraction degree.

Thus, when a user searches a conference content, a search screen displays keywords obtained based on an attribution in a hierarchical structure for each time as an index word. As a result, the user can easily find out a target part from the conference information DB recording a conference content while referring to the index word.

Another technique ensures simply displaying and switching a remark spoken and recorded during an ongoing conference for each speaker corresponding to a state of a progress of proceedings.

A tag cloud, which displays a plurality of tags (words) like clouds (clouds), has recently employed as a method to display many words.

For example, yet another technique changes a tag display method corresponding to importance considering an aspect of correlation between tags and/or a temporal aspect. Here, the temporal aspect changing, for example, a font size to display a tag corresponding to current importance, or changing a font size corresponding to importance at each time over a certain period in the past, and displaying a change trend. The importance corresponds to frequency in a given data set. The correlation is displayed based on a unique grouping, a color coding, or a distance display.

### SUMMARY

An information display system according to an aspect of the disclosure includes a word recognition device, a server, and a plurality of terminals. The word recognition device recognizes a word, and transmits the recognized word to the server. The server includes a first communication circuit, a dictionary, and a first control circuit. The first communication circuit is communicable with the word recognition device and the plurality of terminals. The dictionary stores a plurality of combinations of words and explanations of the respective words. The first control circuit searches an explanation of a word received from the word recognition device in the dictionary, and transmits the received word and the searched explanation to the plurality of terminals. The plurality of terminals each include: a second communication circuit that is communicable with the server; an operation circuit that accepts an operation instruction; a display circuit; a storage circuit that is storable of the explanation; and a second control circuit. When the second communication circuit receives the word and the explanation of the word from the server, the second control circuit causes the display circuit to display the received word and causes the storage circuit to store the received explanation. When accepting a selection of the displayed word via the operation circuit, the second control circuit obtains the explanation corresponding to the selected word from the storage circuit to cause the display circuit to display the obtained explanation.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a configuration of an information display system according to an embodiment of the disclosure.

FIG. 2 illustrates a display example of a word and a meaning of the word on a display unit in a terminal according to the embodiment.

FIG. 3 illustrates steps of an entire process of the information display system according to the embodiment.

FIG. 4 illustrates steps of a first process group for recognizing and displaying a word used in a topic.

FIG. 5 illustrates steps of a second process group for displaying a meaning of a word selected by attendees among displayed words.

FIG. 6 illustrates steps of a third process group for changing a display style of a word corresponding to an elapsed time after displaying (after transmitting) the word.

FIG. 7 illustrates steps of a fourth process group for adding up counts of selections of each word to change a display style of the word based on the count result.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes an embodiment of the disclosure with reference to the drawings. Outline

First, the following describes an outline of an information display system according to an embodiment of the disclosure. The information display system is used in a conference, a presentation, or similar meeting of people. The information display system has two major functions.

As a proceeding or an agenda progresses and time elapses, various words are used in topics (are used) during the conference or the presentation. Here, the word is, for example, a technical word, an abbreviation, a coined word, a modern language, a buzzword, a word not to be commonly recognized, and a foreign word.

A first function of the information display system ensures that the attendee refers to a meaning of a word used in a topic on a terminal, which is a part of the information display system and used by an attendee (user) of a conference or a presentation.

The terminal displays the word used in the topic in real-time. Then, an attendee who desires to know a meaning (explanation) of the word clicks or taps on the displayed word to select the displayed word. Then, the terminal displays the meaning.

This ensures that the attendee finds the meaning without asking a speaker or a presenter, and avoids a state where asking the speaker or the presenter interrupts a flow of conference progress although the attendee comes across an unknown word.

A fewer operations cause the attendee to find the meaning of the word compared with search of the unknown word in Internet. This ensures a reduced resource such as a time for search.

A second function of the information display system adds up counts of selections of words displayed on respective terminals by word, and then feeds back the count results to the respective terminals in real-time.

For example, when a word “smartphone” is used in a topic, the respective attendees' terminals display “smartphone.” When three in ten attendees select the displayed word “smartphone” and a meaning of “smartphone” is displayed on the terminals, a server as a part of the information display system counts the selection actions for the word. After that, the server changes a display style of the word “smartphone” displayed on the respective terminals using a highlighted display (visual effect) such as a font size change and display color change based on the count result.

This ensures that the speaker or the presenter, who has looked at the terminal, finds which word the attendees refer to its meaning and how many attendees refer to the meaning. This allows the speaker or the presenter to explain a word whose meaning is referred by the many attendees in more detail than meanings of the other words on which the terminal displays. Additionally, the speaker or the presenter can save time and proceed a subject without adding an explanation of the word whose meaning is referred by a few attendees.

All attendees can find recognizability of words used in a topic. This ensures smooth progress of a conference or a presentation.

According to the functions described above, use of the information display system causes the terminal to display appropriate information corresponding to a content of an ongoing conference or presentation, thus ensuring efficient proceed of the conference or the presentation.

Screens displayed by the respective attendees' terminals do not need to be exactly the identical. If the respective terminals have only to ensure changing a display style of the currently displayed word based on feedback on a count result from the server, the respective terminals may be configured to allow attendees to freely move or delete many displayed words on the screens.

For example, among displayed words on the terminal, the attendee may delete a word well known by the attendee from the screen, or shunt a word, which has been referred to a meaning and may be referred again, to a side of the screen, so as not to cause an obstruction.

This ensures that the respective attendees perceive the intelligibility of the words among the whole attendees while the respective attendees can have the displayed words organized on the terminals corresponding to their respective intelligibilities. Thus, the respective attendees deeply understand a conference content or a presentation content.

The words displayed on the terminal may be faded out due to a smaller font size or a paler displayed color corresponding to an elapsed time. This assumes that words are used in topics one after another as proceeding progresses in a conference or a presentation, and the words used in the topics are commonly less important as time elapses.

This ensures preventing a situation where the terminal displays are occupied by too many words, although the proceeding progresses.

On the other hand, it is possible to extend the time until the word is faded out or the word is not faded out if the word is referred to a meaning by many attendees.

The above has described an outline of the information display system according to the embodiment of the disclosure.

### Configuration

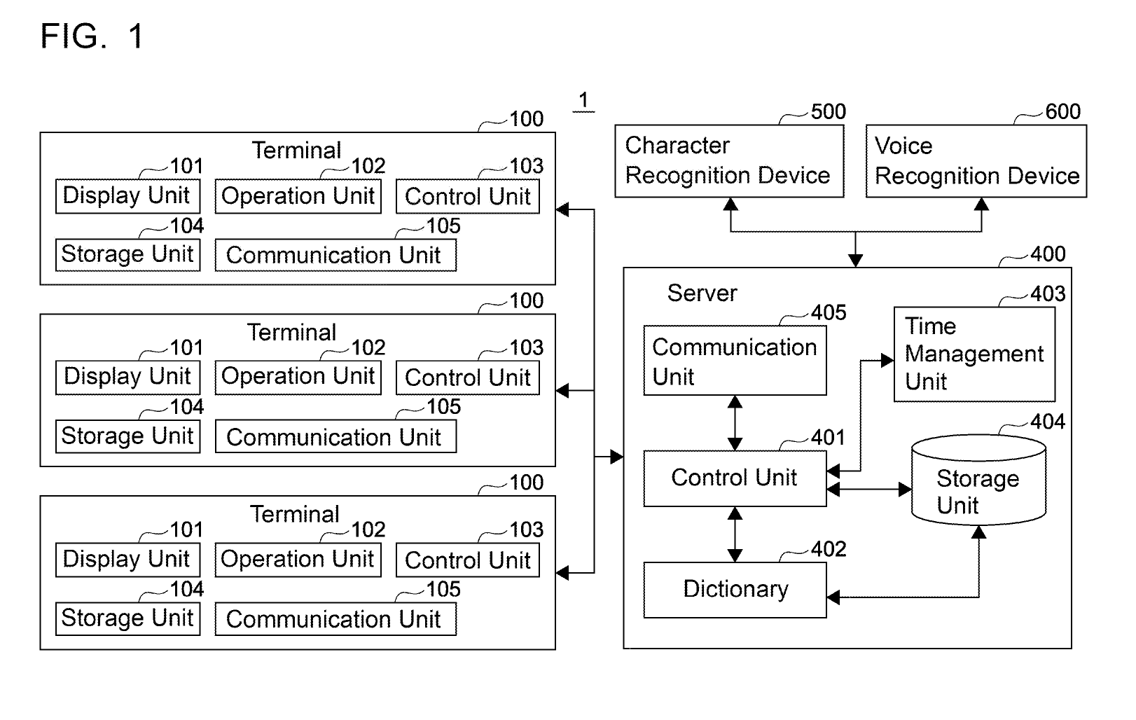

Next, the following describes a configuration of the information display system according to the embodiment of the disclosure. FIG. 1 illustrates a configuration of an information display system 1 according to the embodiment of the disclosure.

The information display system 1 includes a plurality of terminals 100, a server 400, a character recognition device 500, and a voice recognition device 600. The terminal 100 and the server 400 may employ a typical computer. The following assumes that a tablet type computer is used as hardware of the terminal 100, and a personal computer (PC) is used as hardware of the server 400. The following describes only a main block without a detailed description of the whole information display system 1. The character recognition device 500 and the voice recognition device 600 are also referred to as a word recognition device. It is enough to include at least one of the above devices.

The terminals 100 are used by the respective attendees (including a presenter) of a conference or a presentation. The terminal 100 includes a display unit 101, an operation unit 102, a control unit 103 (second control unit), a storage unit 104, and a communication unit 105 (second communication unit).

The display unit 101 is a circuit that includes a screen that displays the words used in a topic during a conference as tag clouds or displays a meaning of a word selected by the attendees. The following describes the details.

The operation unit 102 is a circuit that accepts operation instructions from the attendee who uses the terminal 100. Specifically, the operation instructions include, for example, an operation of selecting a word displayed on the display unit 101 by a click or a tap, an operation of deleting the displayed word, and an operation of moving a display position of the displayed word.

The control unit 103 is a processor that controls the respective units in the terminal 100. Particularly, the control unit 103 causes the display unit 101 to display a word received from the server 400 based on an instruction on a display style similarly received from the server 400. When the displayed word is selected by the operation unit 102, the control unit 103 causes the communication unit 105 to transmit the selected word and the notice of selection of the word to the server 400.

When the attendee selects a word to refer to a meaning of the word displayed on the display unit 101, the storage unit 104 is a circuit that has a storage area storing an explanation of the word to be displayed on the display unit 101. The control unit 103 causes the storage unit 104 to store the explanation received from the server 400.

The communication unit 105 is a circuit that receives a word used in a topic during the conference, a meaning of the word, and an instruction on a display style of the word from the server 400. When the attendee selects the word displayed on the display unit 101, the communication unit 105 transmits the selected word and a notice of selection of the word to the server 400. The terminal 100 and the server 400 may be connected by an exclusive cable or, connected by a wired or a wireless local area network (LAN), for example.

The character recognition device 500 uses, for example, a camera to photograph conference materials or presentation materials that are projected on a screen using a projector or hand written words on a white board during the conference. The character recognition device 500 includes a circuit that executes morphological analysis after optical character recognition (OCR) process. After that, the character recognition device 500 transmits a word determined to be noun or verb to the server 400. A common technique may be employed to configure the character recognition device 500.

The character recognition device 500 may electronically obtain materials used for the presentation, and then extract a word from the obtained data other than using, for example a camera.

The voice recognition device 600 obtains spoken words during the conference using a microphone or similar device and includes a circuit that executes morphological analysis after converting them into texts. After that, the voice recognition device 600 transmits a word determined to be noun or verb to the server 400. A common technique may be employed to configure the voice recognition device 600.

The voice recognition device 600 may directly extract a word from a video or a sound file for the presentation to obtain the word other than using, for example, a microphone.

The server 400 obtains the words, which are used in topics during the conference and recognized by the character recognition device 500 or the voice recognition device 600, searches a meaning of the obtained word, and then obtains its meaning. After that, the server 400 transmits the obtained word and the meaning of the word to the terminal 100. Additionally, the server 400 counts words selected on the terminal 100, and transmits an instruction to change a display style of the word to the terminal 100 based on the count result and an elapsed time after displaying the words.

The server 400 includes a control unit 401 (also referred to as first control unit), a dictionary 402, a time management unit 403, a storage unit 404, and a communication unit 405 (also referred to as first communication unit).

The control unit 401 is a processor that controls the respective units in the server 400.

The dictionary 402 is a database that storing a plurality of combinations of words and meanings of the respective words. The control unit 401 uses the dictionary 402 to search a meaning of a word received from the character recognition device 500 or the voice recognition device 600.

The dictionary 402 may be outside of and independent from the server 400. The dictionary 402 may store a combination of a word and relevant information on the word in addition to the word and a meaning of the word.

The time management unit 403 is a circuit that manages an elapsed time after transmitting a word to the respective terminals 100 from the server 400 for each word displayed on the terminal 100. The elapsed time managed by the time management unit 403 is used for calculating time to cause the word displayed on the terminal 100 to be faded out.

The storage unit 404 is a circuit that includes a storage area storing a count value that how many attendees select the word for each word displayed on the terminal 100.

The communication unit 405 is a circuit that communicates with every terminal 100, the character recognition device 500, and the voice recognition device 600.

The above has described the configuration of the information display system according to the embodiment of the disclosure.

### Display Example on the Terminal 100

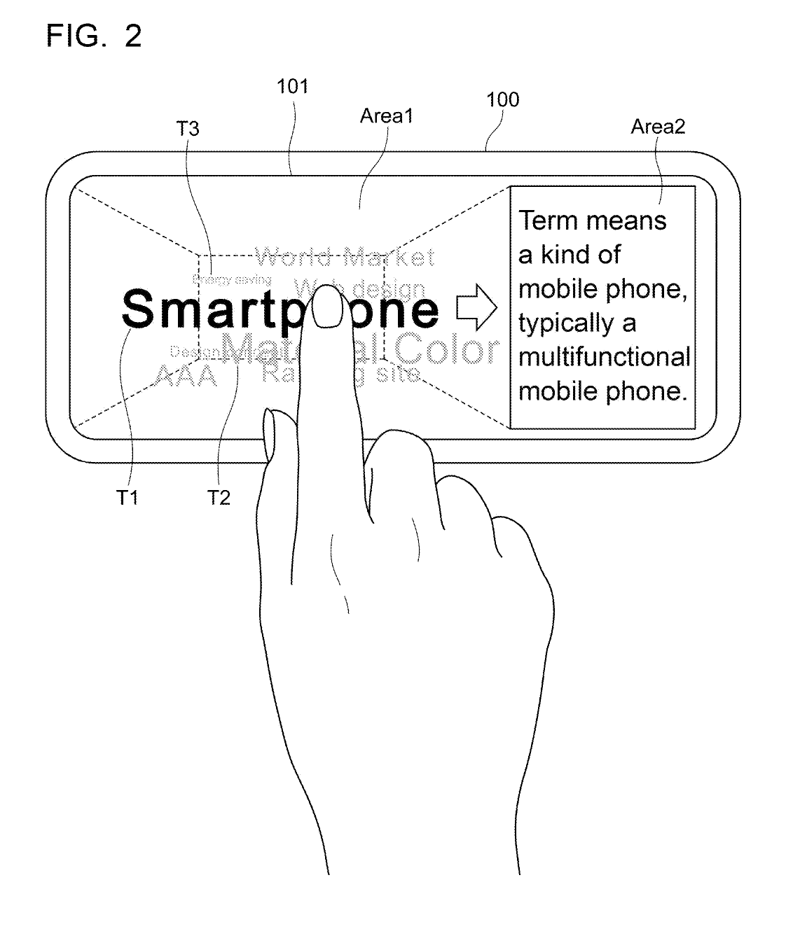

Next, the following describes a display example of a word and a meaning of the word on the display unit 101 in the terminal 100. FIG. 2 illustrates a display example of a word and a meaning of the word on the display unit 101 in the terminal 100.

The screen of the display unit 101 includes an Area1 as an area for displaying words used in topics during the conference as tag clouds and an Area2 as an area for displaying a meaning (explanation) of the selected word when the displayed word is selected.

As illustrated in the Area1 in FIG. 2 by dotted lines, the Area1 displays a word floated into square room in three-dimensional space. As time passes, the Area1 may display the word that has a smaller font or a paler color, or is moved to a back of the square room.

Specifically a state illustrated in FIG. 2 is assumed that a word T1 “smartphone,” which was used in a topic at the most closest past point from the present point is tapped to select by the attendee who uses the terminal 100 displaying this word. As a result of the selection, the Area2 displays the meaning of “smartphone,” “a term that means a kind of mobile phone (omitted the rest).”

FIG. 2 illustrates a word T2 (material color), which was used in a topic at further past point than the word T1 “smartphone.” The word T2 has a paler color than a color of the word T1, and is below the word T1.

A word T3 (energy saving), which was used in a topic at a yet further past point, is displayed on upper left of the word T1, and has a further pale color and a further small font than a font of the word T2.

These words are basically faded out toward the back of the room along with an elapsed time (for example, three minutes) after displaying. However, a period until a word tapped and referred to a meaning of the word by the many attendees is faded out may be extended, a font size of the word and a color strength of the word also may be restored to a display style at a display starting point to reset the fade-out, or the word may be exempt from fade-out.

The above has described the display example of a word and a meaning of the word on the display unit 101 in the terminal 100.

### Process Flow

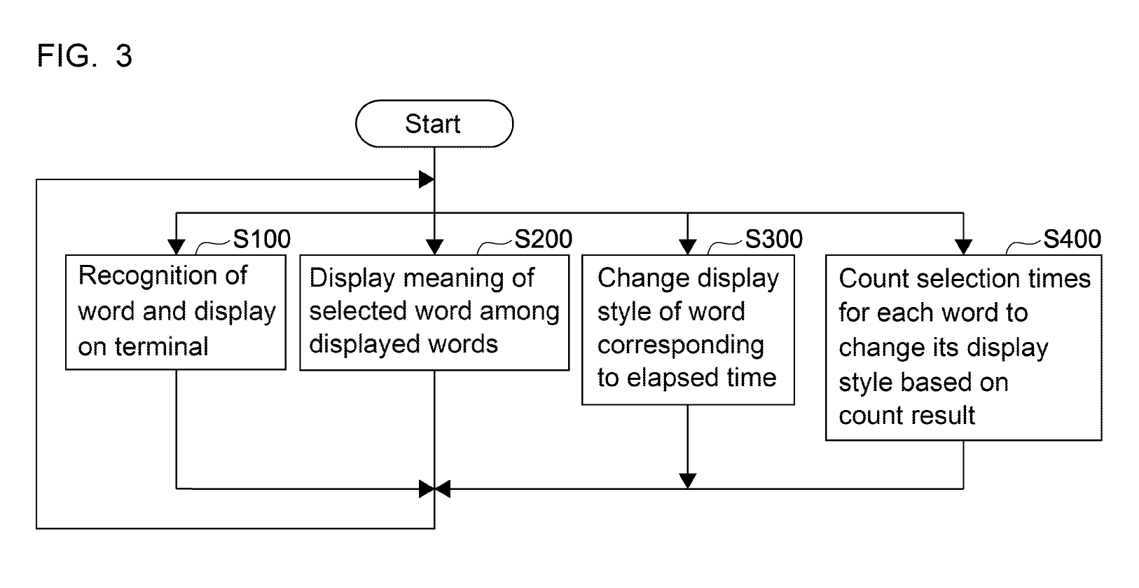

Next, the following describes a process flow of the information display system 1 according to the embodiment of the disclosure. FIGS. 3 to 7 illustrate process steps of the information display system 1 according to the embodiment of the disclosure.

### Overall Process Flow

First, FIG. 3 illustrates a flowchart describing a whole process flow of the information display system 1. The whole process may be roughly divided into four process groups.

A first process group includes processes of recognizing a word used in a topic, and displaying the recognized word on the terminal 100 (Step S100).

A second process group includes a process of, among words displayed on the terminal 100, displaying a meaning of a word selected by the attendee on the terminal 100 (Step S200).

A third process group includes a process of changing a display style of the displayed word corresponding to an elapsed time after the terminal 100 displays the word (Step S300).

A fourth process group includes processes of adding up counts of selections for each word and changing the display style of the displayed word based on the count result (Step S400).

During the conference or the presentation, words appear in topics one after another. This causes these four process groups to be simultaneously and repeatedly executed.

The above has described the whole process flow of the information display system 1.

### First Process Group: Processes of Recognizing Word Used in Topic and

### Displaying Recognized Word

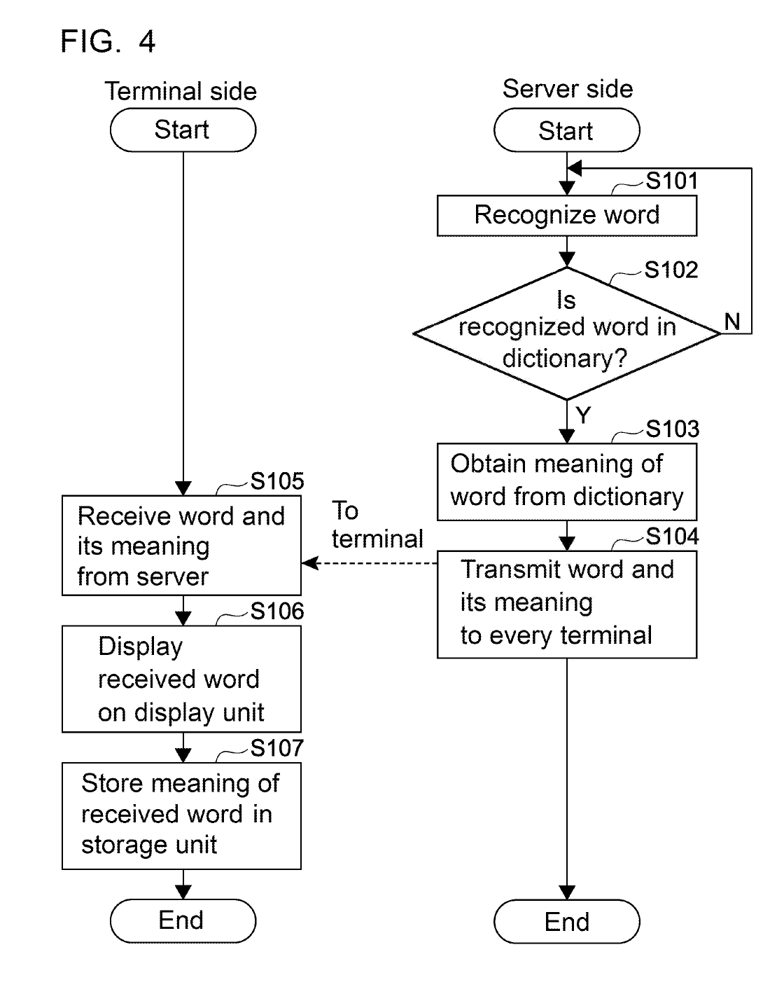

FIG. 4 is a flowchart illustrating a flow of the first process group for recognizing and displaying a word used in a topic.

First, the character recognition device 500 or the voice recognition device 600 recognizes a word used in a topic during the conference, and then transmits the recognized word to the server 400 (Step S101).

Next, the control unit 401 in the server 400 determines whether or not a receive word is present in the dictionary 402, and the server 400 can obtain a meaning of the word (Step S102).

Absence of the received word in the dictionary 402 (No at Step S102) causes the control unit 401 to return to Step S101, and repeatedly receive the recognized word. The process prevents a display of a word whose meaning is absent in the dictionary 402 on the terminal 100 so as to avoid a situation where tag clouds displayed are crowded on the Area1 as an area of the display unit 101 in the terminal 100. The process is executed to prevent a situation where the attendee has a difficulty to see displayed words (to ensure readability).

Thus, when the tag clouds may be crowded, the information display system 1 may be configured to transmit a word that is absent in the dictionary 402 to the terminal 100.

Presence of the received word in the dictionary 402 (Yes at Step S102) causes the control unit 401 to obtain a meaning of the word from the dictionary 402 (Step S103).

Next, the control unit 401 transmits the received word present in the dictionary 402 and the meaning of the word obtained from the dictionary 402 to all the terminals 100 via the communication unit 405 (Step S104).

Then, the control units 103 in the respective terminals 100 each receive the word and the meaning of the word from the server 400 via the communication units 105 (Step S105).

After that, the control units 103 in the respective terminals 100 each display the received word on the display units 101 (Step S106).

Finally, the control units 103 in the respective terminals 100 each store the meaning of the received word on the storage units 104 (Step S107).

The above has described the flow of the process where a word used in a topic is recognized, and then the recognized word is displayed.

Second Process Group: Process of Displaying Meaning of Word Selected by Attendee among Displayed Words

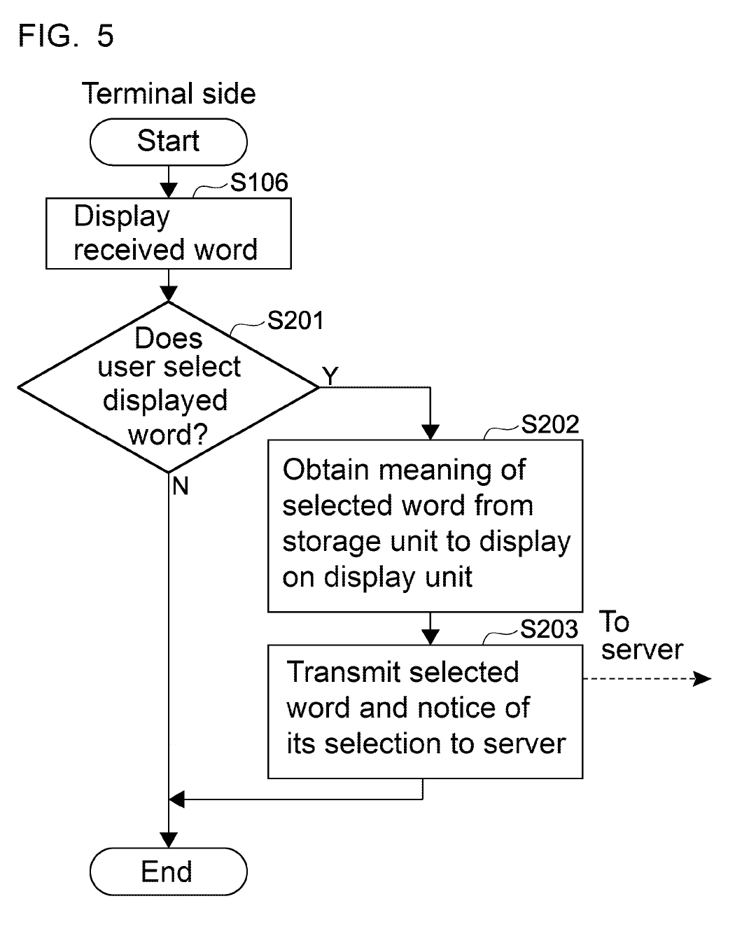

FIG. 5 is a flowchart illustrating a flow of a second process group for displaying a meaning of a word selected by attendees among displayed words.

First, the control unit 103 in the terminal 100 causes the display unit 101 to display a word received from the communication unit 105 (Step S106). This process is a step included in the first process group described above.

Next, the control unit 103 in the terminal 100 determines whether or not the attendee (user of the terminal 100) has selected by click or tap the displayed word (Step S201).

A selection of the displayed word (Yes at Step S201) causes the control unit 103 in the terminal 100 to obtain a meaning of the selected word from the storage unit 104, and then display the meaning on Area2, which is an area of the display unit 101 (Step S202).

After that, the control unit 103 in the terminal 100 transmits the selected word and a notice of selection of the word to the server 400 via the communication unit 105 (Step S203).

The above has described the flow process of displaying a meaning of a word selected by the attendee among the displayed words.

Third Process Group: Process of Changing Display Style of Word Corresponding to Elapsed Time after Displaying

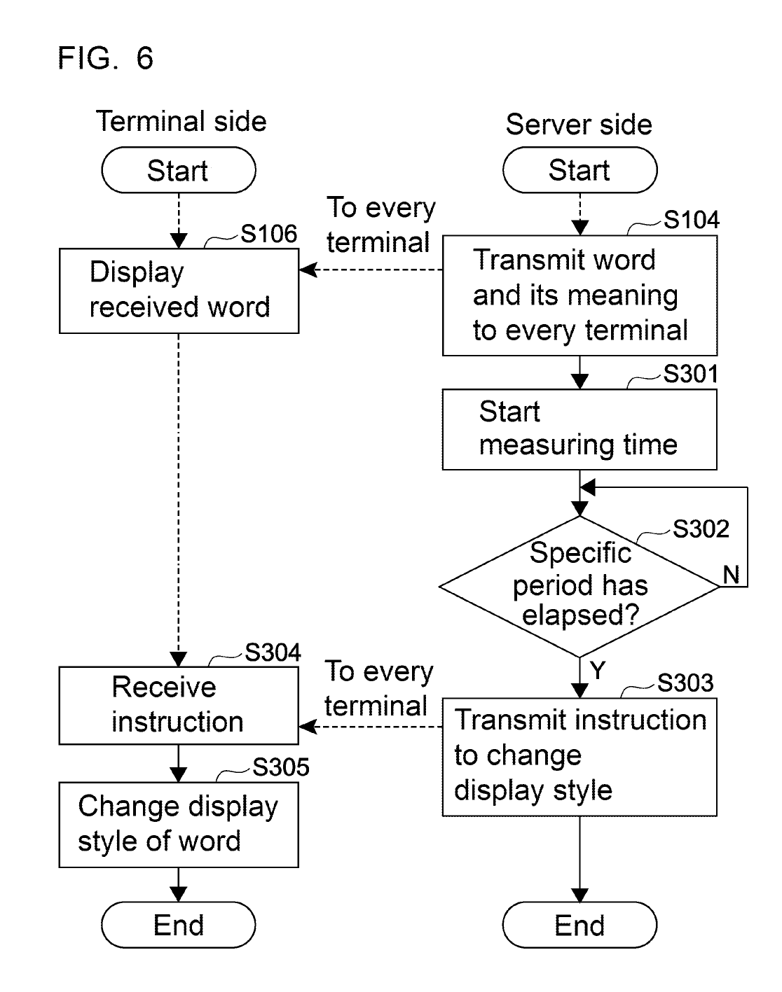

FIG. 6 illustrates a flow of a third process group for changing a display style of a word corresponding to an elapsed time after displaying (after transmitting) the word.

First, the control unit 401 in the server 400 transmits a word and a meaning of the word to all the terminals 100 (Step S104). The first process group described above includes this process.

Next, the control unit 103 in every terminal 100 receives a transmitted word and a meaning of the word from the server 400, and then causes the display unit 101 to display the received word (Step S106). The first process group also includes this process.

After transmitting the word and the meaning of the word to all the terminals 100, the control unit 401 in the server 400 instructs the time management unit 403 to start measuring an elapsed time of the transmitted word (Step S301).

After that, the control unit 401 in the server 400 determines whether or not a predetermined specific period has elapsed (Step S302).

When the specific period has not elapsed yet (No at Step S302), the control unit 401 in the server 400 returns to the previous Step S301 and continues to measure.

After the specific period has elapsed (Yes at Step S302), the control unit 401 in the server 400 transmits an instruction to change a display style of a targeted word to all the terminals 100 (Step S303).

Specifically, a display style change includes the following changes corresponding to an elapsed time after the server 400 transmits the word “smartphone” to every terminal 100.

(1) Changing a font size used to display a word into a smaller size;
(2) Changing a font color used to display a word into a paler color; and
(3) Changing a position where a word is displayed into a further back position in the square room in perspective and three-dimensional space (display Area1 of the display unit 101).

After that, the control units 103 in the respective terminals 100 receive an instruction to change the display style of the targeted word (Step S304).

Finally, the control units 103 in the respective terminals 100 follows the received instruction, and then changes the display style of the targeted word (Step S305).

The above has described the flow process where the display style of the word is changed corresponding to an elapsed time after displaying (after transmitting) the word.

### Fourth Process Group: Processes of Adding Up Counts of Selection Times for Each Word and Changing Display Style Based On Count Result

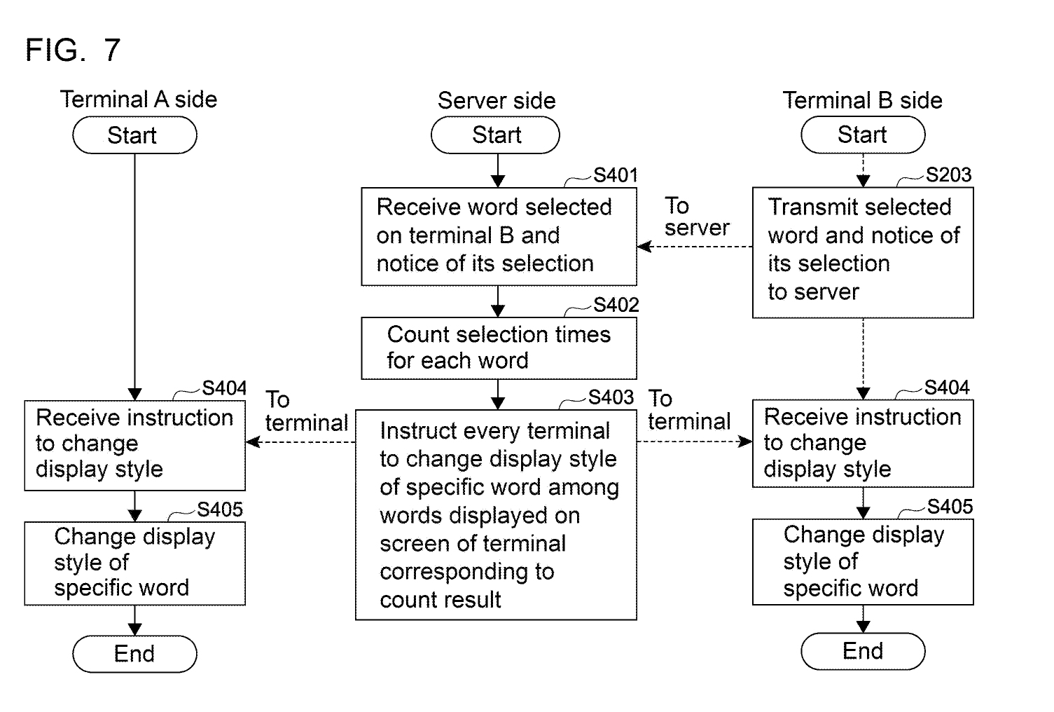

FIG. 7 illustrates a flow of a fourth process group for adding up counts of selections of each word to change a display style of the word based on the count result.

The following describes the flow process of the fourth process group using, in addition to the server 400, a terminal A and a terminal B as examples. The terminal A is the terminal 100 where the attendee does not perform a selection operation to a displayed word. The terminal B is the terminal 100 where the attendee performs a selection operation to the displayed word.

First, the control unit 103 in the terminal B transmits a selected word and a notice of selection of the word to the server 400 (Step S203). The second process group described above includes this process.

Next, the control unit 401 in the server 400 receives a word selected on the terminal B and a notice of selection of the word (Step S401).

The control unit 401 in the server 400 adds up counts of selections of each word (Step S402).

Then, corresponding to the count result, the control unit 401 in the server 400 adjusts an elapsed time value of a targeted specific word among words displayed on screens of the display units 101 in the respective terminals A and B. Then, the control unit 401 in the server 400 transmits an instruction to change a display style based on the adjusted elapsed time value to the respective terminals A and B (Step S403).

Specifically, changing a display style means highlightedly displaying using the following changes.

(1) Changing a font size used to display a word into a larger size;
(2) Changing a font color used to display a word into a deeper color; and
(3) Changing kind of color and moving a position where a word is displayed to, for example, a further front position in the square room in perspective and three-dimensional space (display Area1 of the display unit 101).

The highlighted display described above may be much more highlighted than a display style when starting to display a word.

A method other than the highlightedly displaying a word may be employed as a method to feed back a count of selection of a word. For example, in the proximity of a specific word, it is possible to employ a method such as displaying a percentage of attendee who has referred to the meaning of the word in all the attendees.

In other words, changing a display style means a word being faded out due to an elapsed time after displaying is changed as the following.

(1) Resetting an elapsed time value to zero to restore a font size, a font color, a color strength, and a display position to the initial display; and
(2) Reducing an elapsed time value to extend a period until fade out.

For the display position, a result of a word movement operation, which the attendees perform on the respective terminal 100, may have a priority. This ensures that the respective attendees freely change a word display position, and a state where the display position has been changed is maintained.

After that, the control units 103 in the respective terminals A and B receive an instruction to change a display style of a specific word from the server 400 (Step S404).

Finally, the control unit 103 in the respective terminals A and B change the display style of the specific word (Step S405).

The above has described the flow processes for adding up counts of selection of each word, and then the display style of the displayed word changes based on the count result.

The above has described the flow process of the information display system 1 according to the embodiment of the disclosure.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An information display system comprising:
a word recognition device;
a server; and
a plurality of terminals; wherein
the word recognition device executes to recognize a word and transmit the recognized word to the server;
the server includes
a first communication circuit that is communicable with the word recognition device and the plurality of terminals,
a dictionary that stores a plurality of combinations of words and explanations of the respective words, and
a first control circuit that searches an explanation of a word received from the word recognition device in the dictionary, and transmits the received word and the searched explanation to the plurality of terminals; and
the plurality of terminals each include
a second communication circuit that is communicable with the server,
an operation circuit that accepts an operation instruction,
a display circuit,
a storage circuit that is storable of the explanation, and
a second control circuit, wherein
when the second communication circuit receives the word and the explanation of the word from the server, the second control circuit causes the display circuit to display the received word and causes the storage circuit to store the received explanation, and
when accepting a selection of the displayed word via the operation circuit, the second control circuit obtains the explanation corresponding to the selected word from the storage circuit to cause the display circuit to display the obtained explanation.

2. The information display system according to claim 1, wherein:
when the second control circuit of the terminal accepts a selection of the displayed word via the operation circuit, the second control circuit transmits the selected word and a notice of selection of the word to the server;
when the first control circuit in the server receives the selected word and the notice of selection of the word, the first control circuit adds up counts of selections for each of the words and prepares an instruction of changing a display style of a specific word displayed on the respective display circuits in the plurality of terminals based on the count result to transmit the prepared instruction to the respective terminals; and
when the respective second control circuits in the plurality of terminals receive the instruction, the respective second control circuits in the plurality of terminals change the display style of the specific word based on the received instruction.

3. The information display system according to claim 1, wherein:
the server further includes a time management circuit that manages an elapsed time after transmitting the word to the plurality of terminals for each word;
the first control circuit in the server obtains the elapsed time for each word from the time management circuit and prepares an instruction of changing a display style for each word displayed on the respective display circuits in the plurality of terminals based on the obtained elapsed time to transmit the prepared instruction to the respective plurality of terminals; and
when the respective second control circuits in the plurality of terminals receive the instruction, the respective second control circuits change a display style for each of the words based on the received instruction.

4. The information display system according to claim 1, wherein:
the server further includes a time management circuit that manages an elapsed time after transmitting the word to the plurality of terminals for each of the words;
when the second control circuit in the terminal accepts a selection of the displayed word via the operation circuit, the second control circuit transmits the selected word and a notice of selection of the word to the server;
when the first control circuit in the server obtains the elapsed time of each of the words from the time management circuit and receives the selected word and a notice of selection of the word, the first control circuit in the server adds up counts of the selection of the word by word and adjusts a value of the elapsed time of the obtained specific word based on the count result, prepares an instruction of changing a display style of the specific word displayed on the respective display circuits in the plurality of terminals based on the adjusted elapsed time value, and transmits the prepared instruction to the respective plurality of terminals; and
when the second control circuits receives the instruction, the second control circuits in the respective plurality of terminals change a display style by word based on the received instruction.

5. The information display system according to claim 1, wherein when an explanation of a word received from the word recognition device is present in the dictionary, the first control circuit in the server transmits the received word and the searched explanation to the plurality of terminals.

6. The information display system according to claim 2, wherein the respective second control circuits in the plurality of terminals have a higher priority on an instruction of changing a display style of the displayed word accepted by the operation circuit than an instruction of changing the display style received from the server.

7. The information display system according to claim 1, wherein the word recognition device performs at least one of character recognition and voice recognition.

8. A non-transitory computer-readable recording medium storing an information display program to control a computer to display information on a plurality of terminals corresponding to a word recognized by a word recognition device, the information display program causing a computer to function as:
a control circuit that searches an explanation of the word received from the word recognition device in a dictionary storing a plurality of combinations of the words and explanations of the respective words, and transmits the received word and the searched explanation to the plurality of terminals.

9. A non-transitory computer-readable recording medium storing an information display program to control a computer based on a word received from a server and an explanation of the word, the information display program causing a computer to function as:
a control circuit that when the control circuit receives a word and an explanation of the word from a server, causes a display circuit to display the received word, and causes a storage circuit to store the received explanation; and
when the displayed word is selected via an operation circuit, the control circuit obtains the explanation corresponding to the selected word from the storage circuit and causes the display circuit to display the obtained explanation.
